(19) United States
(12) Patent Application Publication
(10) Pub. No.: US 2018/0363477 A1
(43) Pub. Date: Dec. 20, 2018

(54) COATED CERAMIC MATRIX COMPOSITE OF METALLIC COMPONENT AND METHOD FOR FORMING A COMPONENT

(71) Applicant: GENERAL ELECTRIC COMPANY, Schenectady, NY (US)

(72) Inventors: Matthew Troy HAFNER, Honea Path, SC (US); Joshua Lee MARGOLIES, Niskayuna, NY (US)

(21) Appl. No.: 15/623,802

(22) Filed: Jun. 15, 2017

(51) Int. Cl. F01D 5/28; F23R 3/00; F01D 9/04; F01D 9/02

(52) U.S. Cl. CPC F01D 5/288; F23R 3/007; F01D 9/04; F01D 9/023; F05D 2220/32; F05D 2300/10; F05D 2230/13; F05D 2230/21; F05D 2230/90; F05D 2300/6033; F05D 2240/35

(57) ABSTRACT

A coated ceramic matrix composite or metallic component and a gas turbine assembly is provided. The component comprises a substrate comprising a first surface and a hot gas path surface. The hot gas path surface is arranged and disposed to contact a hot gas flow when the component is installed in the gas turbine. The first surface is disposed at an angle to the hot gas path surface and opposes at least one adjacent component when the component is installed in the gas turbine. The component further comprises an angled or rounded feature extending from the first surface to the hot gas path surface. The component further comprises an environmental barrier coating or thermal barrier coating on at least a portion of the hot gas path surface. The angled or rounded feature reduces an incidence angle of the hot gas flow onto the first surface. The gas turbine assembly comprises a plurality of the coated components.

### FIELD OF THE INVENTION

The present invention is generally directed to a coated ceramic matrix composite or metallic component for a gas turbine and a method of forming a coated ceramic matrix composite or metallic component for a gas turbine. More specifically, the present invention is directed to a coated ceramic matrix composite or metallic component comprising an angled or rounded feature and a method of forming a coated ceramic matrix composite or metallic component comprising an angled or rounded feature.

### BACKGROUND OF THE INVENTION

Certain components, such as components for a gas turbine, operate at high temperatures and pressures. In particular, hot gas flow travels across turbine components at an angle. The surface of turbine components experiencing direct or indirect impingement of hot gas flow may be subject to erosion of the coating from the flow. Known hot gas path components have sharp edged features that result in undesirable hot gas flow impingement. In addition, the sharp edged features result in difficulties forming suitable coatings.

### BRIEF DESCRIPTION OF THE INVENTION

In an exemplary embodiment, a coated ceramic matrix composite or metallic component for a gas turbine is provided. The component comprises a substrate comprising a first surface and a hot gas path surface. The hot gas path surface is arranged and disposed to contact a hot gas flow when the component is installed in the gas turbine. The first surface is disposed at an angle to the hot gas path surface and opposes at least one adjacent component when the component is installed in the gas turbine. The component further comprises an angled or rounded feature extending from the first surface to the hot gas path surface. The component further comprises an environmental barrier coating or thermal barrier coating on at least a portion of the hot gas path surface. The angled or rounded feature reduces an incidence angle of the hot gas flow onto the first surface.

In another exemplary embodiment, a gas turbine assembly comprising a plurality of a coated ceramic matrix composite component is provided. The component comprises a substrate comprising a first surface and a hot gas path surface. The hot gas path surface is arranged and disposed to contact a hot gas flow when the component is installed in the gas turbine. The first surface is disposed at an angle to the hot gas path surface and opposes at least one adjacent component when the component is installed in the gas turbine. The component further comprises an angled or rounded feature extending from the first surface to the hot gas path surface. The component further comprises an environmental barrier coating or thermal barrier coating on at least a portion of the hot gas path surface. The angled or rounded feature reduces an incidence angle of the hot gas flow onto the first surface.

In another exemplary embodiment, a method for forming a coated ceramic matrix composite or metallic component is provided. The method comprises a step of providing a component having a substrate comprising a first surface and a hot gas path surface. The method further comprises a step of forming an angled or rounded feature extending from the first surface to the hot gas path surface. The method further comprises a step of forming an environmental barrier coating or thermal barrier coating on at least a portion of the hot gas path surface. The hot gas path surface is arranged and disposed to contact a hot gas flow when the component is installed in the gas turbine. The first surface is disposed at an angle to the hot gas path surface and opposes at least one adjacent component when the component is installed in the gas turbine. The angled or rounded feature reduces an incidence angle of the hot gas flow onto the first surface.

Other features and advantages of the present invention will be apparent from the following more detailed description of the preferred embodiment, taken in conjunction with the accompanying drawings, which illustrate, by way of example, the principles of the invention.

### BRIEF DESCRIPTION OF THE DRAWINGS

FIG. 1 illustrates a coated ceramic matrix composite or metallic component for a gas turbine.

FIG. 2 illustrates a sectional view taken at the line 2-2 in FIG. 1.

FIG. 3 illustrates a top view of a gas turbine assembly comprising a plurality of a coated ceramic matrix composite component.

FIG. 4 illustrates a sectional view taken at the line 4-4 in FIG. 3.

FIG. 5 illustrates a sectional view of a coated ceramic matrix composite or metallic component for a gas turbine, according to the present disclosure, taken at the line 5-5 in FIG. 3.

FIG. 6 illustrates a sectional view of a known coated ceramic matrix composite or metallic component for a gas turbine taken at the line 6-6 in FIG. 3.

FIG. 7 illustrates a magnified view of a circled portion of FIG. 6.

FIG. 8 illustrates a flow diagram of a process for forming a coated ceramic matrix composite or metallic component for a gas turbine.

Wherever possible, the same reference numbers will be used throughout the drawings to represent the same parts.

### DETAILED DESCRIPTION OF THE INVENTION

Provided are exemplary methods and coated ceramic matrix composite or metallic components. Embodiments of the present disclosure, in comparison to methods and coated ceramic matrix composite or metallic components not utilizing one or more features disclosed herein, provide an environmental barrier coating or thermal barrier coating to the first side of the components and prevent erosion of the coating, thereby prolong the part life.

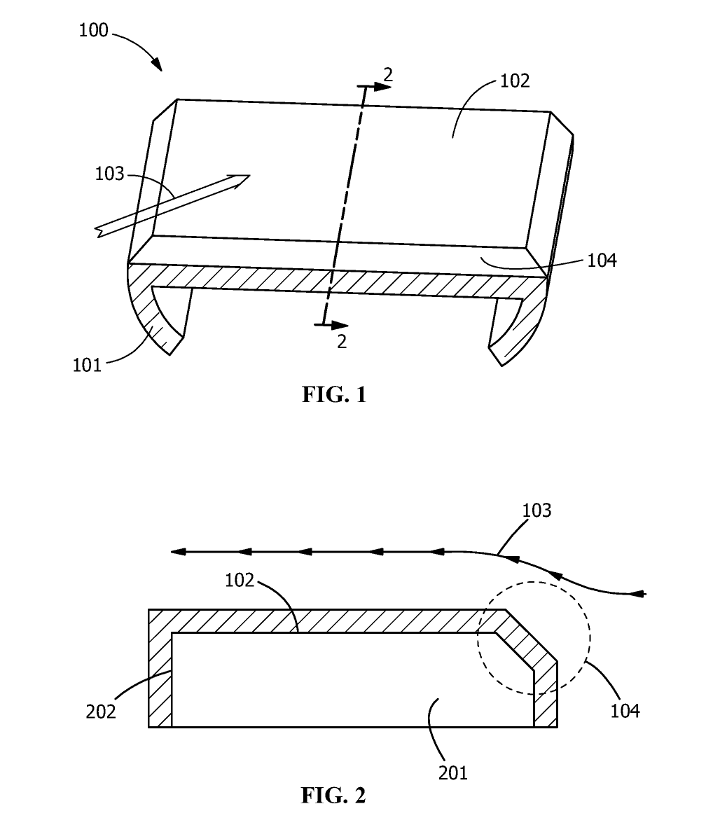

With reference to FIGS. 1 and 2, a coated ceramic matrix composite or metallic component 100 for a gas turbine, according to the present disclosure, is provided. Component 100 comprises a substrate 201 comprising a first surface 101 and a hot gas path surface 102. Hot gas path surface 102 is arranged and disposed to contact a hot gas flow 103 when component 100 is installed in the gas turbine. First surface 101 is disposed at an angle to hot gas path surface 102 and opposes at least one adjacent component when component 100 is installed in the gas turbine. Opposing components include components that are installed in their operating configuration and include one or more surfaces that face each other or otherwise arranged in a manner where surfaces are adjacent one another, whether in contacted or not. (see for example FIG. 4) The angle between hot gas path surface 102 and first surface 101 is the angle between a plane oriented along hot gas path surface 102 and a plane oriented along first surface 101. In one embodiment, first surface 101 is a leading slashface surface. Component 100 further comprises an angled or rounded feature 104 extending from first surface 101 to hot gas path surface 102. In one embodiment, metallic component 100 further comprises a coating 202 on at least a portion of hot gas path surface 102. Metallic component 100 may optionally include coating 202 on at least a portion of first surface 101. In another embodiment, ceramic matrix composite component 100 further comprises coating 202 on at least a portion of hot gas path surface 102. Ceramic matrix composite component 100 may optionally include coating 202 on first surface 101. Ceramic matrix composite component 100 may also need protection on angled or rounded feature 104 that intersect hot gas path surface 102 to alleviate or reduce the need for cooling air to purge the cavities or gaps between the parts. In another embodiment, coating 202 is disposed on an entire surface of the component 100. Coating 202 may include, for example, an environmental barrier coating or a thermal barrier coating. Angled or rounded feature 104 reduces an incidence angle of hot gas flow 103 onto first surface 101.

In one embodiment, substrate 201 comprises a ceramic matrix composite material selected from the group consisting of carbon-fiber-reinforced silicon carbide (C/SiC), silicon-carbide-fiber-reinforced silicon carbide (SiC/SiC), carbon-fiber-reinforced silicon nitride (C/Si₃N₄), silicon nitride-silicon carbide composite (Si₃N₄/SiC), alumina-fiber-reinforced alumina (Al₂O₃/Al₂O₃), and combinations thereof.

In one embodiment, substrate 201 comprises a metallic component. The metallic component may include, but not be limited to, stainless steels, titanium superalloy, cobalt superalloy and nickel superalloy.

In one embodiment, coating 202 comprises a bond coat and a top coat. In another embodiment, coating 202 consists of a bond coat and a top coat. In another embodiment, coating 202 comprises a bond coat and multiple top coats. In another embodiment, coating 202 consists of a bond coat and multiple top coats. In another embodiment, coating 202 comprises multiple bond coats and a top coat. In another embodiment, coating 202 consists of multiple bond coats and a top coat. In another embodiment, coating 202 comprises multiple bond coats and multiple top coats. In another embodiment, coating 202 consists of multiple bond coats and multiple top coats. In another embodiment, coating 202 comprises at least one bond coat, at least one thermally grown oxide layer and at least one top coat. In another embodiment, coating 202 consists of at least one bond coat, at least one thermally grown oxide layer and at least one top coat.

In one embodiment, suitable bond coat comprises a material selected from the group consisting of silicon, silicon-based alloy, silicon-based composite, silicon dioxide, MCrAlY and combinations thereof wherein M is Ni, Co, Fe, or mixtures thereof. A person skilled in the art will appreciate that any suitable bond coat materials are envisaged.

In one embodiment, coating 202 further comprises a transition layer comprising a material selected from the group consisting of barium strontium alumino silicate (BSAS), mullite, yttria-stabilized zirconia, (Yb,Y)₂Si₂O₇, rare earth monosilicates and disilicates and combinations thereof. A person skilled in the art will appreciate that any suitable TBC or EBC materials are envisaged.

In one embodiment, suitable top coat comprises a material selected from the group consisting of Y₂SiO₅, barium strontium alumino silicate (BSAS), yttria-stabilized zirconia, yttria-stabilized hafnia, yttria-stabilized zirconia with additions of one or more rare earth oxides, yttria-stabilized hafnia with additions of one or more rare earth oxides and combinations thereof. A person skilled in the art will appreciate that any suitable top coat materials are envisaged.

In one embodiment, coated ceramic matrix composite or metallic component 100 may include shrouds, nozzles, blades, combustors, combustor transition pieces, combustor liners, combustor tiles and combinations thereof. A person skilled in the art will appreciate that any suitable coated ceramic matrix composite or metallic components are envisaged.

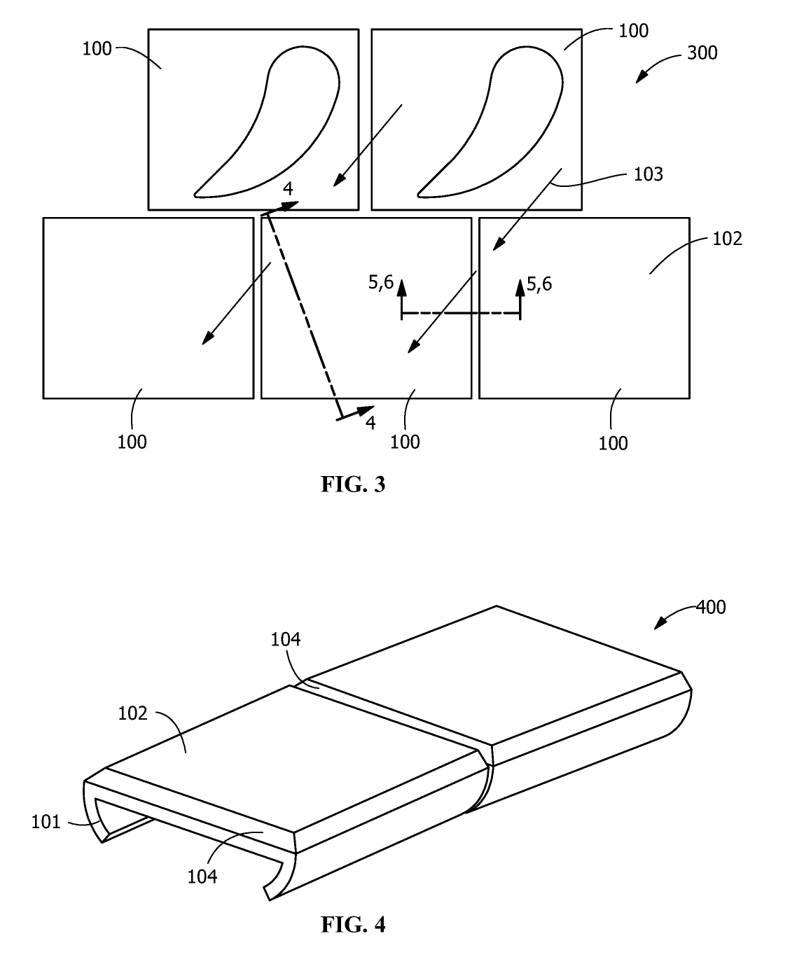

With reference to FIGS. 3 and 4, a gas turbine assembly 300 is provided. Gas turbine assembly 300 comprises a plurality of a coated ceramic matrix composite or metallic component 100. The plurality of component comprises substrate 201 comprising first surface 101 and hot gas path surface 102. Hot gas path surface 102 is arranged and disposed to contact hot gas flow 103. First surface 101 is disposed at an angle to hot gas path surface 102 and opposes at least one adjacent component in gas turbine assembly 300. The component further comprises angled or rounded feature 104 extending from first surface 101 to hot gas path surface 102.

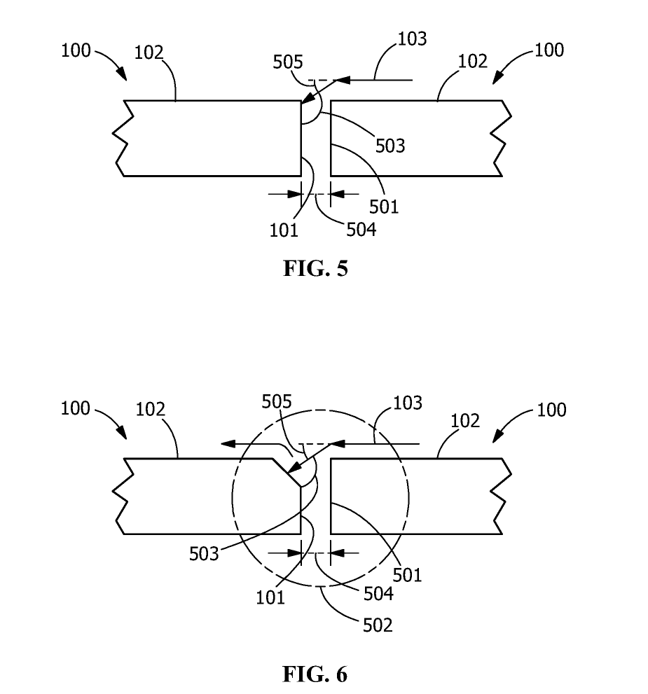

With reference to FIGS. 5 and 6, a sectional view taken at the line 5,6-5,6 in FIG. 3 is provided. As seen in FIG. 5, known systems do not include angled or rounded feature 104, but includes a sharp edge, wherein an incident angle 503 of hot gas flow 103 onto first surface 101 is high, therefore leading to unfavorable impingement on opposed component 100 within an intersegment gap 504. As seen in FIG. 6, component 100, according to an embodiment of the disclosure, includes angled or rounded feature 104, wherein angled or rounded feature 104 reduces incidence angle 503 of hot gas flow 103 onto first surface 101, therefore leading to favorable dynamics between intersegment gap 504 and along with incidence angle 503. Hot gas flow 103, and then, ascends along angled or rounded feature 104 and flows along hot gas path surface 102.

In one embodiment, intersegment gap 504 is between about 0.05 and about 0.1 inches, between about 0.06 and about 0.09 inches, or between about 0.07 and about 0.08 inches, including increments, intervals, and sub-range therein, in the hot operating condition or at steady state operation.

In one embodiment, hot gas flow 103 is naturally directed at a deflection angle 505 in a downward direction and directed toward angled or rounded feature 104 as it passes intersegment gap 504 due to gas density, gas speed and gas pressure. In one embodiment, hot gas flow 103 is directed 7-9° in a downward direction and directed toward angled or rounded feature 104 as it passes intersegment gap 504. In another embodiment, hot gas flow 103 is directed 5°-15°, 6°-14°, 7°-13°, 8°-12°, or 9°-11°, including increments, intervals, and sub-range therein, in a downward direction and directed toward angled or rounded feature 104 as it passes an intersegment gap 504.

In one embodiment, second surface 501 of an opposing or adjacent component is defined to be a surface opposing to first surface 101, wherein first surface 101 and second surface 501 face each other.

In one embodiment, second surface 501 does not include an angled or rounded feature. In another embodiment, second surface 501 includes an angled or rounded feature.

With reference to FIG. 7, a magnified view of a circled portion 502 of FIG. 6 is provided. In one embodiment, slope angle 701 is between about 15 and about 45 degrees, between about 20 and about 40 degrees, between about 25 and about 35 degrees, including increments, intervals, and sub-range therein. Slope angle 701 is defined an angle between a plane oriented along hot gas path surface 102 and a plane oriented along angled or rounded feature 104. Angled or rounded feature 104 may comprise a flat surface, a curved face, a radius, a chamber or other smoothly transitioning geometry. In one embodiment, angled or rounded feature 104 has a height 702 between hot gas path surface 102 and first surface 101. Height 702 is between about 0.05 inches (min) and about 0.4 inches (max), between about 0.1 inches and about 0.4 inches, or between about 0.2 inches and about 0.3 inches, including increments, intervals, and sub-range therein. In one embodiment, height 702 is greater than or equal to gap 504. In one embodiment, height 702 can be up to four times gap 504, but can't be more than the thickness of the part. Larger height 702 is bad for aerodynamic efficiency since it increases the average gap between hot gas components.

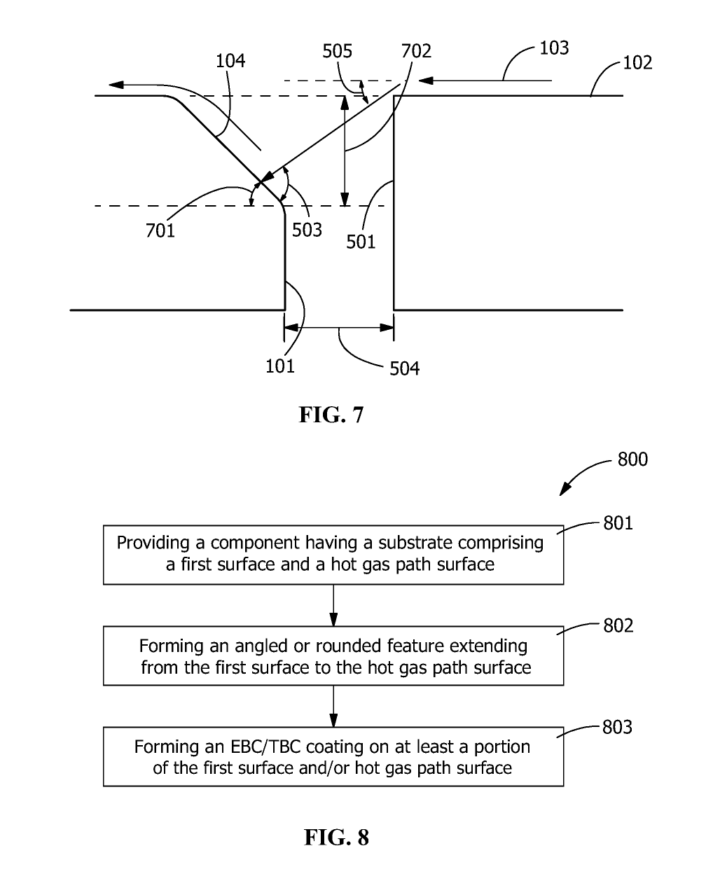

With reference to FIG. 8, a method 800 for forming a coated ceramic matrix composite or metallic component 100 is provided. The method comprises a step of providing a component 100 having a substrate 201 comprising a first surface 101 and a hot gas path surface 102 (step 801). The method further comprises a step of forming an angled or rounded feature 104 extending from first surface 101 to hot gas path surface 102 (step 802). The method further comprises the step of forming an environmental barrier coating or thermal barrier coating 202 on at least a portion of first surface 101 and/or hot gas path surface 102 (step 803). Hot gas path surface 102 is arranged and disposed to contact a hot gas flow 103 when the component is installed in the gas turbine. First surface 101 is disposed at an angle to hot gas path surface 102 and opposes at least one adjacent component when the component 100 is installed in the gas turbine. Angled or rounded feature 104 reduces an incidence angle 503 of the hot gas flow onto the first surface.

In one embodiment, the step of forming the angled or rounded feature (step 802) may include a process selected from casting, layup, machining, grinding, laser ablation, waterjet, and combinations thereof. In one embodiment, the step of forming coating 202 (step 803) comprises at least one of physical vapor deposition, chemical vapor deposition, plasma-enhanced chemical vapor deposition, air plasma spray, vacuum plasma spray, combustion spraying with powder or rod, slurry coating, sol gel, dip coating, electrophoretic deposition, tape casting, and additive manufacturing techniques.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A coated ceramic matrix composite or metallic component for a gas turbine, comprising:
a substrate comprising a first surface and a hot gas path surface, the hot gas path surface being arranged and disposed to contact a hot gas flow when the component is installed in the gas turbine, and the first surface being disposed at an angle to the hot gas path surface and opposing at least one adjacent component when the component is installed in the gas turbine;
an angled or rounded feature extending from the first surface to the hot gas path surface; and
an environmental barrier coating or thermal barrier coating on at least a portion of the hot gas path surface;
wherein the angled or rounded feature reduces an incidence angle of the hot gas flow onto the first surface.

2. The coated ceramic matrix composite or metallic component of claim 1, wherein the angled or rounded feature has a slope angle of between about 15 and about 45 degrees.

3. The coated ceramic matrix composite or metallic component of claim 1, wherein the substrate comprises a ceramic matrix composite material selected from the group consisting of carbon-fiber-reinforced silicon carbide (C/SiC), silicon-carbide-fiber-reinforced silicon carbide (SiC/SiC), carbon-fiber-reinforced silicon nitride (C/Si₃N₄), silicon nitride-silicon carbide composite (Si₃N₄/SiC), alumina-fiber-reinforced alumina (Al₂O₃/Al₂O₃), titanium superalloy, cobalt superalloy, nickel superalloy and combinations thereof.

4. The coated ceramic matrix composite or metallic component of claim 1, wherein the environmental barrier coating or thermal barrier coating comprises a bond coat and one or multiple top coats.

5. The coated ceramic matrix composite or metallic component of claim 4, wherein the bond coat comprises a material selected from the group consisting of silicon, silicon-based alloy, silicon-based composite, silicon dioxide, MCrAlY and combinations thereof wherein M is Ni, Co, Fe, or mixtures thereof.

6. The coated ceramic matrix composite or metallic component of claim 4, wherein the environmental barrier coating or thermal barrier coating further comprises a transition layer comprising a material selected from the group consisting of barium strontium alumino silicate (BSAS), mullite, yttria-stabilized zirconia, (Yb,Y)₂Si₂O₇ and combinations thereof.

7. The coated ceramic matrix composite or metallic component of claim 4, wherein the top coat comprises a material selected from the group consisting of Y₂SiO₅, barium strontium alumino silicate (BSAS), yttria-stabilized zirconia, yttria-stabilized hafnia, yttria-stabilized zirconia with additions of one or more rare earth oxides, yttria-stabilized hafnia with additions of one or more rare earth oxides and combinations thereof.

8. The coated ceramic matrix composite or metallic component of claim 1, wherein the coated ceramic matrix composite or metallic component is selected from the group consisting of shrouds, nozzles, blades, combustors, combustor transition pieces, combustor liners, combustor tiles and combinations thereof.

9. A gas turbine assembly comprising:
a plurality of a coated ceramic matrix composite or metallic component, comprising:
a substrate comprising a first surface and a hot gas path surface, the hot gas path surface being arranged and disposed to contact a hot gas flow, and the first surface being disposed at an angle to the hot gas path surface and opposing at least one adjacent component in the gas turbine assembly;
an angled or rounded feature extending from the first surface to the hot gas path surface; and
an environmental barrier coating or thermal barrier coating on at least a portion of the hot gas path surface;
wherein the angled or rounded feature reduces an incidence angle of the hot gas flow onto the first surface.

10. The gas turbine assembly of claim 9, wherein the coated ceramic matrix composite or metallic component is selected from the group consisting of shrouds, nozzles, blades, combustors, combustor transition pieces, combustor liners, combustor tiles and combinations thereof.

11. The gas turbine assembly of claim 9, wherein the angled or rounded feature has a slope angle of less than about 15 degrees.

12. A method for forming a coated ceramic matrix composite or metallic component, comprising:
providing a component having a substrate comprising a first surface and a hot gas path surface;
forming an angled or rounded feature extending from the first surface to the hot gas path surface; and
forming an environmental barrier coating or thermal barrier coating on at least a portion of the hot gas path surface;
wherein the hot gas path surface is arranged and disposed to contact a hot gas flow when the component is installed in the gas turbine, and the first surface is disposed at an angle to the hot gas path surface and opposing at least one adjacent component when the component is installed in the gas turbine, and
wherein the angled or rounded feature reduces an incidence angle of the hot gas flow onto the first surface.

13. The method of claim 12, wherein the step of forming the angled or rounded feature is a process selected from the group consisting of casting, layup, machining, grinding, laser ablation, waterjet, and combinations thereof.

14. The method of claim 12, wherein the step of forming the environmental barrier coating or thermal barrier coating comprises at least one of physical vapor deposition, chemical vapor deposition, plasma-enhanced chemical vapor deposition, air plasma spray, vacuum plasma spray, combustion spraying with powder or rod, slurry coating, sol gel, dip coating, electrophoretic deposition, tape casting, and additive manufacturing techniques.

15. The method of claim 12, wherein the angled or rounded feature has a slope angle of less than about 15 degrees.

16. The method of claim 12, wherein the substrate comprises a ceramic matrix composite material selected from the group consisting of carbon-fiber-reinforced silicon carbide (C/SiC), silicon-carbide-fiber-reinforced silicon carbide (SiC/SiC), carbon-fiber-reinforced silicon nitride (C/Si₃N₄), silicon nitride-silicon carbide composite (Si₃N₄/SiC), alumina-fiber-reinforced alumina (Al₂O₃/Al₂O₃), and combinations thereof.

17. The method of claim 12, wherein the environmental barrier coating or thermal barrier coating comprises a bond coat and one or multiple top coats.

18. The method of claim 17, wherein the bond coat comprises a material selected from the group consisting of silicon, silicon-based alloy, silicon-based composite, silicon dioxide, MCrAlY and combinations thereof; wherein M is Ni, Co, Fe, or mixtures thereof.

19. The method of claim 17, wherein the environmental barrier coating or thermal barrier coating further comprises a transition layer comprising a material selected from the group consisting of barium strontium alumino silicate (BSAS), mullite, yttria-stabilized zirconia, (Yb,Y)₂Si₂O₇ and combinations thereof.

20. The method of claim 17, wherein the top coat comprises a material selected from the group consisting of Y₂SiO₅, barium strontium alumino silicate (BSAS), yttria-stabilized zirconia, yttria-stabilized hafnia, yttria-stabilized zirconia with additions of one or more rare earth oxides, yttria-stabilized hafnia with additions of one or more rare earth oxides and combinations thereof.
